(19) United States
(12) Patent Application Publication
(10) Pub. No.: US 2007/0216291 A1
(43) Pub. Date: Sep. 20, 2007

(54) Organic light emitting diode display and method of manufacturing the same

(76) Inventor: Kwang-Chul Jung, Seongnam-si (KR)

Correspondence Address: CANTOR COLBURN, LLP, 55 GRIFFIN ROAD SOUTH, BLOOMFIELD, CT, 06002, US

(21) Appl. No.: 11/508,021

(22) Filed: Aug. 22, 2006

(30) Foreign Application Priority Data
Mar. 20, 2006 (KR) 10-2006-0025173

(51) Int. Cl. H01J 1/62

(52) U.S. Cl. 313/506

(57) ABSTRACT

An organic light emitting diode display includes an organic light emitting diode panel which transmits light downward to display an image, an adhesive member attached on the organic light emitting diode panel, a circuit film attached on the adhesive member, and a printed circuit board connected with the circuit film, wherein the circuit film and the printed circuit board are positioned at the upper portion of the organic light emitting diode panel and the circuit film is absent a fold. Thus, because the printed circuit board is positioned above the organic light emitting diode panel, and the circuit film that connects a driving chip and the printed circuit board need not be folded, the circuit film does not come off of the organic light emitting diode panel, and thus, the production yield can be enhanced.

This application claims priority to Korean Patent Application No. 10-2006-0025173, filed on Mar. 20, 2006, and all the benefits accruing therefrom under 35 U.S.C. §119, the contents of which in its entirety are herein incorporated by reference.

### BACKGROUND OF THE INVENTION

(a) Field of the Invention

The present invention relates to an organic light emitting diode (“OLED”) display.

(b) Description of the Related Art

Recently, as the demand for thin and lightweight monitors and televisions has been increasing, the cathode ray tubes (“CRTs”) have increasingly been replaced by light emitting and receiving devices, such as liquid crystal displays (“LCDs”). However, the LCD is disadvantageous in that it requires a backlight and has many problems regarding its response speed and viewing angle. Thus, OLED displays have lately received increased attention as a display device that can overcome the problems of the LCDs.

The OLED display includes two electrodes and an emission layer positioned therebetween. In the OLED display, electrons injected from one electrode and holes injected from the other electrode are combined in the emission layer to form exitons. As the exitons discharge energy, the OLED display is illuminated.

The OLED display is controlled by a driving circuit connected with gate lines and data lines. The driving circuit can be attached according to a tape carrier package (“TCP”) method or a chip-on-glass (“COG”) method. The TCP method uses a TCP with a driving chip attached thereon that is attached to a substrate. In the COG method, the driving chip is directly attached to the substrate. The driving circuit is connected to a circuit formed on a printed circuit board (“PCB”) by a flexible printed circuit film (“FPC”). In this case, because the circuit film is flexible, it is folded downward to allow the PCB to be positioned at a lower side of the substrate. However, in the case of a bottom emission type of OLED display that displays images by transmitting light downward of the substrate, the PCB cannot be positioned at the lower side of the substrate, so the flexible circuit film is folded upward to allow the PCB to be positioned at an upper side of the substrate.

### BRIEF SUMMARY OF THE INVENTION

If the circuit film attached to the substrate is folded in the opposite direction of the direction of an attached portion, the attached portion of the circuit film may easily come off.

The present invention has been made in an effort to provide an organic light emitting diode display in which a circuit film is attached firmly enough so as to not come off.

An exemplary embodiment of the present invention provides an organic light emitting diode display including an organic light emitting diode panel which transmits light downward to display an image, an adhesive member attached to the organic light emitting diode panel, a circuit film attached to the adhesive member, and a printed circuit board connected with the circuit film, wherein the circuit film and the printed circuit board may be positioned at the upper portion of the organic light emitting diode panel and the circuit film is absent a fold.

The organic light emitting diode panel may include a display unit for displaying images and a periphery part (edge part) surrounding the display unit, and the circuit film may be attached at the periphery part.

On the display unit, a plurality of gate lines, a plurality of data lines and a plurality of thin film transistors may be formed.

At the periphery part, a plurality of gate driving chips and a plurality of data driving chips may be formed and connected with the gate lines and the data lines, respectively, and the gate driving chips and data driving chips may be connected with the circuit film.

The circuit film may be an insulation film on which a wiring pattern is formed.

The adhesive member can be an anisotropic conductive film, and the circuit film may be attached as a single layer with the adhesive member.

Another exemplary embodiment of the present invention provides an organic light emitting diode display including an organic light emitting diode panel which transmits light downward to display an image, an adhesive member attached on the organic light emitting diode panel, a tape carrier package attached to the adhesive member, and a printed circuit board connected with the tape carrier package, wherein the tape carrier package and the printed circuit board may be positioned at an upper portion of the organic light emitting diode panel and the tape carrier package is absent a fold.

The organic light emitting diode panel may include a display area for displaying images and a periphery area surrounding the display area, and the tape carrier package may be attached at the periphery area.

In the display area, a plurality of gate lines, a plurality of data lines and a plurality of thin film transistors may be formed, and the tape carrier package can be a circuit film on which a plurality of gate driving chips and a plurality of data driving chips are attached.

One end of each of the data driving chips may be connected with one data line through the circuit film, and the other ends of the data driving chips may be connected with the printed circuit board through the circuit film.

The adhesive member can be an anisotropic conductive film, and the circuit film may be attached as a single layer with the adhesive member.

Still another exemplary embodiment of the present invention provides a method of manufacturing an organic light emitting diode display. The method includes attaching an adhesive member on an organic light emitting diode panel which transmits light downward to display an image, attaching a circuit film on the adhesive member, and connecting a printed circuit board with the circuit film. The circuit film and the printed circuit board are positioned at the upper portion of the organic light emitting diode panel, and the circuit film is absent a fold.

### BRIEF DESCRIPTION OF THE DRAWINGS

The above and other features and advantages of the present invention will become more apparent by describing in more detail exemplary embodiments thereof with reference to the attached drawings, in which:

FIG. 1 is an equivalent circuit schematic of an organic light emitting diode (OLED) display according to an exemplary embodiment of the present invention;

FIG. 2 is a top plan view of the OLED display according to the exemplary embodiment of the present invention;

FIG. 3 is a cross-sectional view taken along line III-III of the OLED display in FIG. 2;

FIG. 4 is a plan view layout of a pixel of an OLED panel of the OLED display according to the exemplary embodiment of the present invention;

FIGS. 5 and 6 are cross-sectional views taken along lines V-V and VI-VI, respectively, of the OLED display in FIG. 4;

FIG. 7 is a top plan view of the OLED display according to another exemplary embodiment of the present invention; and

FIG. 8 is a cross-sectional view taken along line VIII-VIII of the OLED display in FIG. 7.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

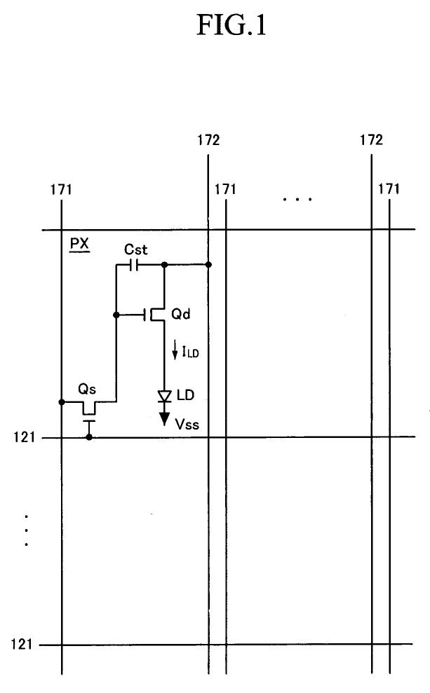

The organic light emitting diode (“OLED”) display according to an exemplary embodiment of the present invention will now be described in detail with reference to FIG. 1. FIG. 1 is an equivalent circuit schematic of an OLED according to one exemplary embodiment of the present invention.

With reference to FIG. 1, the OLED display according to the present exemplary embodiment of the present invention includes a plurality of signal lines 121, 171 and 172, and a plurality of pixels (PXs) arranged substantially in a matrix.

The signal lines include a plurality of gate lines 121 for transferring gate signals (or scan signals), a plurality of data lines 171 for transferring data signals and a plurality of driving voltage lines 172 for transferring driving voltages. The gate lines 121 extend substantially in a row direction and are substantially parallel with each other, and the data lines 171 and the driving voltage lines 172 extend substantially in a column direction and are also substantially parallel with each other.

Each pixel (PX) includes a switching transistor (Qs), a driving transistor (Qd), a storage capacitor (Cst) and an OLED (LD).

The switching transistor Qs includes a control terminal, an input terminal and an output terminal. The control terminal is connected with the gate line 121, the input terminal is connected with the data line 171 and the output terminal is connected with the driving transistor Qd. The switching transistor Qs transfers a data signal applied to the data line to the driving transistor Qd in response to a scan signal applied to the gate line 121.

The driving transistor Qd also includes a control terminal, an input terminal and an output terminal. The control terminal is connected with the switching transistor Qs, the input terminal is connected with the driving voltage line 172, and the output terminal is connected with the OLED LD. The driving transistor Qd outputs an output current (I_{LD}) that varies depending on a voltage applied between the control terminal and the output terminal of the driving transistor Qd.

The storage capacitor Cst is connected between the control terminal and the input terminal of the driving transistor Qd. The capacitor Cst charges data signals applied to the control terminal of the driving transistor Qd and sustains the data signals even after the switching transistor Qs is turned off.

The OLED LD includes an anode connected with the output terminal of the driving transistor Qd and a cathode connected with a common voltage Vss. The OLED LD displays images when illuminated, and the amount of illumination varies depending on the output current I_{LD} of the driving transistor Qd.

The switching transistor Qs and the driving transistor Qd are n-channel field effect transistors (“FETs”). However, at least one of the switching transistor Qs and the driving transistor Qd can be a p-channel FET. The connection relationship of the transistors Qs and Qd, the capacitor Cst and the OLED LD may be changed.

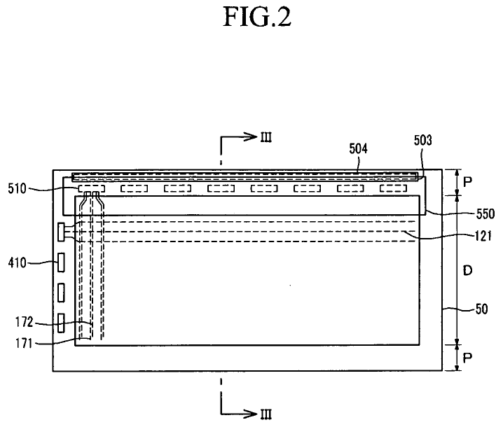

A detailed structure of the OLED display illustrated in FIG. 1 will be described with reference to FIGS. 2 to 6.

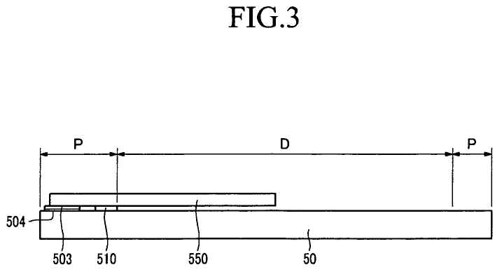

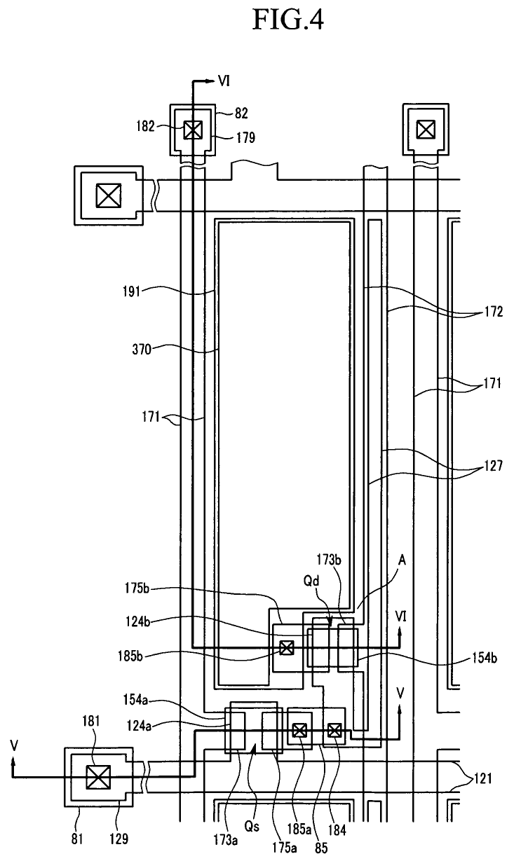

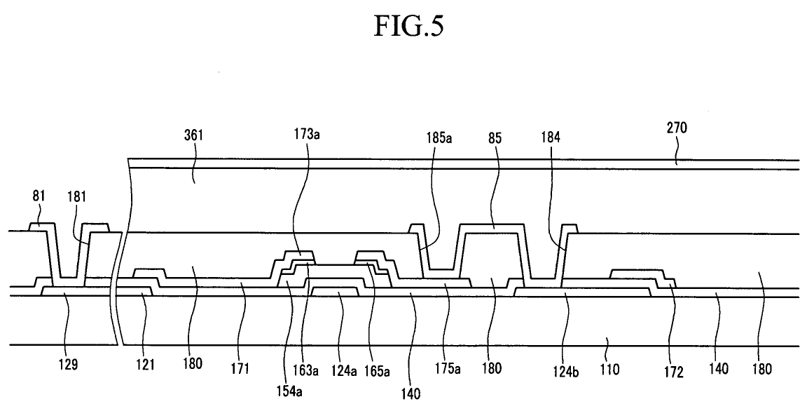

FIG. 2 is a top plan view of the OLED display according to one exemplary embodiment of the present invention, and FIG. 3 is a cross-sectional view taken along line III-III of the OLED display in FIG. 2. FIG. 4 is a plan view layout of a pixel of an OLED panel of the OLED display according to one exemplary embodiment of the present invention, and FIGS. 5 and 6 are cross-sectional views taken along lines V-V and VI-VI, respectively, of the OLED display in FIG. 4.

As shown in FIGS. 2 and 3, the OLED display includes an OLED panel 50 that displays images and has the plurality of signal lines 121, 171 and 172 and a plurality of pixels formed thereon, a printed circuit board (“PCB”) 550 on which a control circuit for transmitting a control signal to the OLED panel 50 is formed, and a circuit film 503 for connecting the OLED panel 50 and the PCB 550. An adhesive member 504 is formed between the circuit film 503 and the OLED panel 50 to attach them.

The OLED panel 50 can be divided into a display unit D on which the gate lines 121, the data lines 171 and the TFTs are formed to display images, and a periphery part P positioned at an outer side of the display unit D.

The display unit D transmits light downward of the OLED panel 50 to display images. The periphery part P includes a plurality of driving chips 410 and 510 that are arranged at certain intervals and connected with the data lines 171 or gate lines 121. The driving chips 410 and 510 can be divided into data driving chips 510 and gate driving chips 410 for inputting image signals and scan signals, respectively. The gate driving chips 410 and the data driving chips 410 are connected with the gate lines 121 and the data lines 171, respectively.

The circuit film 503 is attached at an outer side of the data driving chips 510. The circuit film 503 is an insulation film made of polyimide, or similar material, on which a wiring pattern has been formed, and is attached as a single layer, without being folded, on the OLED panel 50.

The PCB 550 is attached at one end of the circuit film 503, and the PCB 550 is positioned at an upper portion of the OLED panel 50. This is because the downward side of the OLED panel 50 is for displaying images.

Preferably, the adhesive member 504 is formed as an anisotropic conductive film (“ACF”) that is formed by scattering conductive particles in a thermo-hardening or thermoplastic resin film. The circuit film 503 and the OLED panel 50 are electrically and physically connected through an adhesive member 504.

Various circuit elements (not shown) for generating image signals and scan signals to be inputted to the driving chips 410 and 510 are formed on the PCB 550. Signals generated from various circuit elements are transferred from the PCB 550 to the data driving chips 510 through the circuit film 503 formed between the PCB 550 and the data driving chips 510.

Because the PCB 550 is positioned above the OLED panel 50, the circuit film 503 that connects the driving chips 510 and the PCB 550 need not be folded. Therefore the circuit film 503 cannot come off of the OLED panel 50, thus enhancing a production yield.

In addition, after the circuit film 503 is attached on the OLED panel 50, it need not be folded, so time for the fabrication process can be shortened. Moreover, because the circuit film 503 need not be folded, a flexible material need not be used for forming the circuit film 503, thus reducing the expense thereof.

In addition, because an alignment direction for attaching the circuit film 503 and the PCB 550 need only be changed during a current fabrication process, an additional manufacturing apparatus is not required.

The detailed structure of the OLED panel 50 will be described with reference to FIGS. 4 to 6.

As shown in FIGS. 4 to 6, a plurality of gate conductors that include the plurality of gate lines 121 including a plurality of first control electrodes 124a, and a plurality of second control electrodes 124b are formed on the insulation substrate 110 made of transparent glass or plastic.

The gate lines 121 transfer gate signals, and extend mainly in the horizontal direction. Each gate line 121 includes a large end portion 129 for a connection with a different layer or an external driving circuit, and the first control electrode 124a extends upward from the gate line 121. When a gate driving circuit (not shown) for generating gate signals is integrated with the substrate 110, the gate line 121 can extend to be directly connected with the gate driving circuit.

The second control electrode 124b is separated from the gate line 121, and includes a storage electrode 127 that extends in a downward direction, changes its direction to the right side, and then continuously extends upward, as best seen with reference to FIG. 4.

The gate conductors 121 and 124b may be made of an aluminum group metal such as aluminum (Al) or an aluminum alloy, a silver group metal such as silver (Ag) or a Ag alloy, a copper group metal such as copper (Cu) or a copper alloy, a molybdenum group metal such as molybdenum (Mo) or a molybdenum alloy, chromium (Cr), tantalum (Ta) and titanium (Ti), for example. The gate conductors 121 and 124b may have a multilayer structure including two conductive layers (not shown), each with different physical properties. One of the two conductive layers may be made of a metal with low resistivity, for example, the aluminum group metal, the Ag group metal, the copper group metal, for example, to reduce a signal delay or a voltage drop. The other one of the two conductive layers may be made of a different material, for example, the molybdenum group metal, chromium, titanium, and tantalum, for example, which has good physical, chemical and electrical contact characteristics with indium tin oxide (ITO) and indium zinc oxide (IZO). Good examples of the combination include a combination of a chromium lower layer and an upper aluminum (alloy) layer, and a combination of a lower aluminum (alloy) layer and an upper molybdenum (alloy) layer. In addition, the gate conductors 121 and 124b can be made of various other metals or conductors.

Preferably, the sides of the gate conductors 121 and 124b slant to the surface of the substrate 110 with a tilt angle, and the tilt angle is within the range of about 30° to about 80°.

A gate insulating layer 140 made of a silicon nitride (SiNx) or silicon oxide (SiOx), for example, is formed on the gate conductors 121 and 124b.

A plurality of first and second semiconductor islands 154a and 154b made of hydrogenated amorphous silicon (a-Si) or polycrystalline silicon, for example, are formed on the gate insulating layer 140. The first and second semiconductor islands 154a and 154b are positioned at an upper side of the first and second control electrodes 124a and 124b, respectively.

A pairs of first ohmic contacts 163a and 165a and a pair of second ohmic contacts 163b and 165b are formed on the first and second semiconductor islands 154a and 154b, respectively. The ohmic contacts 163a, 163b, 165a and 165b have an island shape and can be made of a material such as n+ hydrogenated amorphous silicon (a-Si) in which an n-type impurity such as phosphor is doped with high density, or silicide. The first ohmic contacts 163a and 165a are disposed as a pair on the first semiconductor island 154a, and the second ohmic contacts 163b and 165b are disposed as a pair on the second semiconductor island 154b.

A plurality of data conductors including the plurality of data lines 171, a plurality of driving voltage lines 172, and a plurality of first and second output electrodes 175a and 175b are formed on the ohmic contacts 163a, 163b, 165a and 165b, and on the gate insulating layer 140.

The data lines 171 transfer data signals, and extend mainly in the vertical direction to cross the gate lines 121. Each data line 171 includes a plurality of first input electrodes 173a extending toward the first control electrode 124a, and a large end portion 179 for connection with a different layer or an external driving circuit. When the data driving circuit (not shown) for generating data signals is integrated with the substrate 110, the data line 171 can extend to be directly connected with the data driving circuit.

The driving voltage line 172 transfers a driving voltage, and extends mainly in the vertical direction to cross the gate line 121. Each driving voltage line 172 includes a plurality of second input electrodes 173b extending toward the second control electrode 124b. The driving voltage line 172 overlaps the storage electrode 127, and the driving voltage line 172 and the storage electrode 127 may be connected.

The first and second output electrodes 175a and 175b are separated from each other, and are also separated from the data line 171 and the driving voltage line 172. The first input electrode 173a and the first output electrode 175a face and are centered on the first control electrode 124a. The second input electrode 173b and the second output electrode 175b face and are centered on the second control electrode 124b.

Preferably, the data conductors 171, 172, 175a and 175b are made of a metal such as molybdenum, chromium, tantalum, and titanium, for example, or an alloy thereof, and may have a multilayer structure including a metal film (not shown) and a low resistance conductive layer (not shown). For example, the multilayer structure can include a dual-layer of a chromium or molybdenum (alloy) lower layer and an upper aluminum (alloy) layer, or a triple-layer of a lower molybdenum (alloy) layer, a middle aluminum (alloy) layer, and an upper molybdenum (alloy) layer. In addition, the data conductors 171, 172, 175a and 175b can be made of various other metals or conductors.

Like the gate conductors 121 and 124b, preferably the sides of the data conductors 171, 172, 175a and 175b also slant with a tilt angle of about 30° to about 80° with respect to the surface of the substrate 110.

The ohmic contacts 163a, 163b, 165a and 165b are present only between the lower semiconductor islands 154a and 154b and the upper data conductors 171, 172, 175a and 175b to lower contact resistance therebetween. The semiconductor islands 154a and 154b include some exposed portions, which are not covered with the data conductors 171, 172, 175a and 175b, such as portions located between the input electrodes 173a and 173b and the output electrodes 175a and 175b.

A passivation layer 180 is formed on the data conductors 171, 172, 175a and 175b and on the exposed portions of the semiconductor islands 154a and 154b. The passivation layer 180 is made of an inorganic insulator, an organic insulator or an insulator with a low dielectric constant, such as silicon nitride (SiNx) or silicon oxide (SiOx), for example. Preferably, a dielectric constant of the organic insulator and the insulator with a low dielectric is below 4.0, and a-Si:C:O or a-Si:O:F, for example, formed according to a plasma enhanced chemical vapor deposition (“PECVD”) can be taken as an example thereof. The passivation layer 180 can be made of an organic insulator with photosensitivity, and the surface of the passivation layer 180 can be smooth. In addition, the passivation layer 180 can have a dual-layer structure having a lower inorganic layer and an upper organic layer so as to obtain excellent insulation characteristics and to protect the exposed portions of the semiconductor islands 154a and 154b.

A plurality of contact holes 182, 185a and 185b are formed at the passivation layer 180 to expose the end portion 179 of the data line 171 and the first and second output electrodes 175a and 175b, respectively. At the passivation layer 180 and a gate insulation layer 140, a plurality of contact holes 181 and 184 are formed to expose the end portion 129 of the gate line 121 and the second input electrode 124b, respectively.

A plurality of pixel electrodes 191, a plurality of connecting members 85 and a plurality of contact assistants 81 and 82 are formed on the passivation layer 180. The plurality of pixel electrodes 191, the plurality of connecting members 85 and the plurality of contact assistants 81 and 82 can be made of a transparent conductive material such as ITO or IZO, or a reflective metal such as aluminum, silver, or their alloys.

The pixel electrode 191 is physically and electrically connected with the second output electrode 175b via the contact hole 185b, and the connecting member 85 is connected with the second control electrode 124b and the first output electrode 175a via the contact holes 184 and 185a, respectively.

The contact assistants 81 and 82 are connected with the end portion 129 of the gate line 121 and the end portion 179 of the data line 171 via the contact holes 181 and 182, respectively. The contact assistants 81 and 82 complement bonding characteristics between the end portion 129 of the gate line 121 and the end portion 179 of the data line 171 and an external device, and protect them.

A partition 361 is formed on the passivation layer 180. The partition 361 defines an opening 365 by surrounding the periphery of an edge of the pixel electrode 191 like a bank, and is made of an organic insulator or an inorganic insulator. The partition 361 can be made of a photoresist including a black pigment, and in this case, the partition 361 serves as a light blocking member and can be formed through a simple process.

An organic light emitting member 370 is formed in the opening 365 on the pixel electrode 191 defined by the partition 361. The organic light emitting member 370 is made of an organic material that emits light of one of three primary colors of red, green and blue. The OLED display displays a desired image as the spatial sum of basic color lights emanated from the organic light emitting members 370.

The organic light emitting members 370 can have a multilayer structure including an auxiliary layer (not shown) for enhancing luminance efficiency of an emission layer that emits light in addition to the emission layer (not shown). The auxiliary layer may include an electron transport layer (not shown) and a hole transport layer (not shown) for balancing electrons and holes, and an electron injecting layer (not shown) and a hole injecting layer (not shown) for strengthening injection of electrons and holes, for example.

A common electrode 270 is formed on the organic light emitting member 370.

The common electrode 270 receives a common voltage Vss, and is made of a reflective metal including calcium (Ca), barium (Ba), magnesium (Mg), aluminum (Al), silver (Ag), or similar material, or a transparent conductive material such as ITO or IZO, for example.

In the OLED display, the first control electrode 124a connected with the gate line 121 and the first input electrode 173a and the first output electrode 175a connected with the data line 171 constitute a switching thin film transistor (“TFT”) Qs together with the first semiconductor island 154a. A channel of the switching TFT Qs is formed at the first semiconductor island 154a between the first and second output electrodes 173a and 175a. The second control electrode 124b connected with the first output electrode 175a, the second input electrode 173b connected with the driving voltage line 172, and the second output electrode 175b connected with the pixel electrode 191 constitute the driving TFT Qd together with the second semiconductor island 154b. A channel of driving TFT Qd is formed at the second semiconductor island 154b between the second input electrode 173b and the second output electrode 175b. The pixel electrode 191, the organic light emitting member 370, and the common electrode 270 constitute the OLED LD, and in this case, the pixel 191 can be an anode and the common electrode 270 can be a cathode, or conversely, the pixel electrode 191 can be a cathode and the common electrode 270 can be an anode. The storage electrode 127 and the driving voltage line 172 that overlap with each other form the storage capacitor Cst.

The OLED display displays an image by transmitting light downward of the substrate 110. A bottom emission type of OLED display including the transparent pixel electrode 191 and the opaque common electrode 270 displays an image in a downward direction of the substrate 110.

When the semiconductor islands 154a and 154b are made of polysilicon, they include an intrinsic region (not shown) facing the control electrodes 124a and 124b and an extrinsic region (impurity region) (not shown) positioned at both sides of the intrinsic region. The extrinsic region is electrically connected with the input electrodes 173a and 173b and the output electrodes 175a and 175b, and the ohmic contacts 163a, 163b, 165a and 165b can be omitted.

The control electrodes 124a and 124b can be positioned on the semiconductor islands 154a and 154b, and in this case, the gate insulating layer 140 is also positioned between the semiconductor islands 154a and 154b and the control electrodes 124a and 124b. The data conductors 171, 172, 173b and 175b are positioned at an upper portion of the gate insulating layer 140, and can be electrically connected with the semiconductor islands 154a and 154b via contact holes (not shown) formed at the gate insulating layer 140. Differently, the data conductors 171, 172, 173b and 175b can be positioned at a lower portion of the semiconductor islands 154a and 154b and electrically contacting the upper semiconductor islands 154a and 154b.

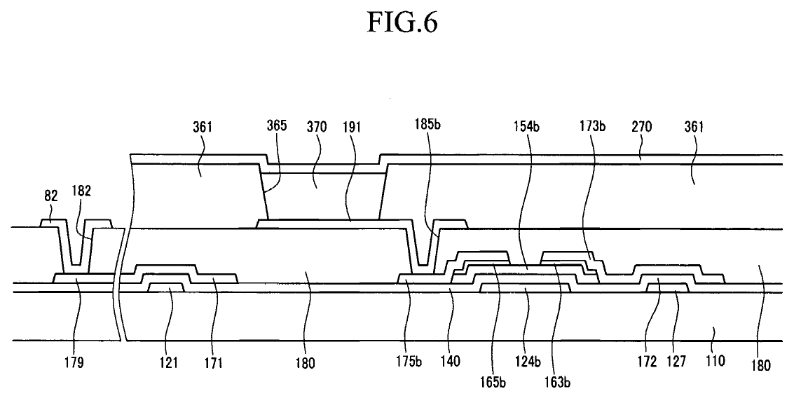

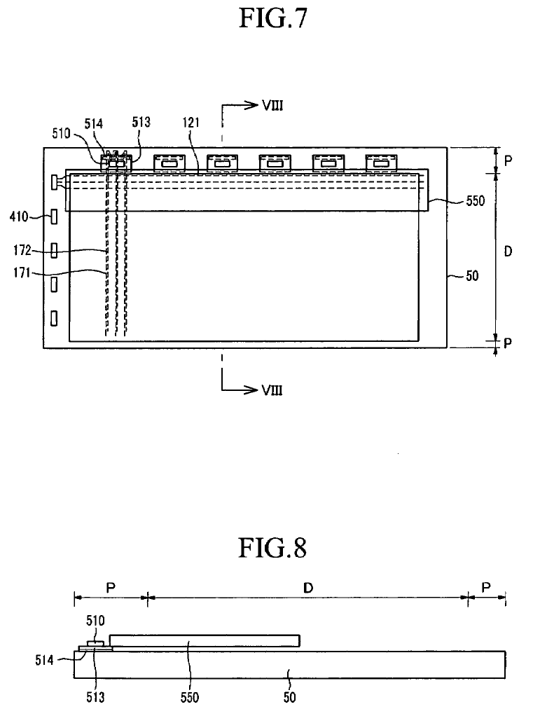

The present exemplary embodiment of the present invention describes the direction of attachment of the circuit film and the PCB when the gate driving chips and the data driving chips are directly formed on the OLED panel, but in addition to this, the present invention can also be applied to a case where the gate driving chips and the data driving chips are formed on the OLED panel by using a tape carrier package (“TCP”). The case where the gate driving chips and the data driving chips are formed on the OLED panel by using a tape carrier package will be described with reference to FIGS. 7 and 8.

FIG. 7 is a top plan view of the OLED display according to another exemplary embodiment of the present invention, and FIG. 8 is a cross-sectional view taken along line VIII-VIII of the OLED display in FIG. 7.

With reference to FIGS. 7 and 8, the OLED display includes an OLED panel 50 that displays images and has the plurality of signal lines 121, 171 and 172 and a plurality of pixels formed thereon, a printed circuit board (“PCB”) 550 on which a control circuit for transmitting a control signal to the OLED panel 50 is formed, and TCPs 513 for connecting the OLED panel 50 and the PCB 550.

An adhesive member 514 is formed between the TCP 513 and the OLED panel 50 to attach them together.

The OLED panel 50 can be divided into a display unit D on which the gate lines 121, the data lines 171 and TFTs are formed to display images. A periphery part P is positioned at an outer side of the display unit D.

The display unit D transmits light downward of the OLED panel 50 to display images. On the periphery part P, a plurality of gate driving chips 410 for inputting scan signals are formed. The TCPs 513 on which data driving chips 510 for inputting image signals are mounted, are respectively, attached. The gate driving chips 410 and the data driving chips 510 are connected with the gate lines 121 and the data lines 171, respectively.

The TCP 513 is a circuit film on which the data driving chip 510 is mounted. One end of the data driving chip 510 is connected with the data lines 171 through wiring of the circuit film 513 and the other end of the data driving chip 510 is connected with the PCB 550 through wiring of the circuit film 513. The TCP 513 is connected as a single layer with the PCB 550, without being folded.

The TCP 513 and the PCB 550 are positioned above the OLED panel 50, because images are displayed downward with respect to the OLED panel 50.

In this manner, by positioning the TCPs 513 and the PCB 550 above the OLED panel 50, TCPs 513 that connect the OLED panel 50 and the PCB 550 need not be folded, so that the TCPs 513 cannot come off of the OLED panel 50, thus enhancing a production yield.

Therefore, in the OLED display according to the present exemplary embodiment of the present invention, because the PCB is positioned above the OLED panel, the circuit film that connects the driving chips and the PCB need not be folded, removing the possibility that the circuit film comes off of the OLED panel, thus enhancing the production yield.

The exemplary embodiments of the present invention have been described in detail, and it will be apparent to those skilled in the art that various modifications and variation can be made in the present invention without departing from the spirit or scope of thereof. Therefore, it is to be understood that the claim coverage of the present invention is not limited to the disclosed exemplary embodiments, but, on the contrary, is intended to cover various modifications and equivalent arrangements included within the spirit and scope of the appended claims.

What is claimed is:

1. An organic light emitting diode display device comprising:
a display panel which transmits light downward to display an image;
an adhesive member attached on the display panel;
a circuit film attached on the adhesive member; and
a printed circuit board connected with the circuit film,
wherein the circuit film and the printed circuit board are positioned at the upper portion of the display panel, and the circuit film is absent a fold.

2. The device of claim 1, wherein the display panel comprises a display area for displaying images and a periphery area surrounding the display area, and the circuit film is attached at the periphery area.

3. The device of claim 2, wherein a plurality of gate lines, a plurality of data lines and a plurality of thin film transistors are formed on the display area.

4. The device of claim 3, wherein a plurality of gate driving chips and a plurality of data driving chips are formed at the periphery area and connected with the gate lines and the data lines, respectively.

5. The device of claim 4, wherein the gate driving chips are connected with the circuit film.

6. The device of claim 4, wherein the data driving chips are connected with the circuit film.

7. The device of claim 5, wherein the circuit film comprises an insulation film on which a wiring pattern is formed.

8. The device of claim 1, wherein the adhesive member comprises an anisotropic conductive film.

9. The device of claim 1, wherein the circuit film is attached as a single layer with the adhesive member.

10. An organic light emitting diode (OLED) display comprising:
an display panel which transmits light downward to display images;
an adhesive member attached on the display panel;
a plurality of tape carrier packages attached on the adhesive member; and
a printed circuit board connected with the tape carrier packages,
wherein each tape carrier package and the printed circuit board are positioned at the upper portion of the display panel, and each tape carrier package is absent a fold.

11. The device of claim 10, wherein the display panel comprises a display area for displaying images and a periphery area surrounding the display area, and the tape carrier packages are attached at the periphery area.

12. The device of claim 11, wherein a plurality of gate lines, a plurality of data lines and a plurality of thin film transistors are formed on the display area.

13. The device of claim 12, wherein each tape carrier package is a circuit film on which a plurality of gate driving chips or a plurality of data driving chips are attached.

14. The device of claim 13, wherein one end of each of the data driving chips is connected with a data line through the circuit film, and the other end of each of the data driving chips is connected with the printed circuit board through the circuit film.

15. The device of claim 10, wherein the adhesive member comprises an anisotropic conductive film.

16. The device of claim 10, wherein the circuit film is attached as a single layer with the adhesive member.

17. A method of manufacturing an organic light emitting diode (OLED) display, the method comprising:
attaching an adhesive member on an display panel which transmits light downward to display an image;
attaching a circuit film on the adhesive member; and
connecting a printed circuit board with the circuit film,
wherein the circuit film and the printed circuit board are positioned at the upper portion of the display panel, and the circuit film is absent a fold.

18. The method of claim 17, wherein the display panel comprises a display area for displaying images and a periphery area surrounding the display area, and the circuit film is attached at the periphery area.

19. The method of claim 18, further comprising forming a plurality of gate lines, a plurality of data lines and a plurality of thin film transistors on the display area.

20. The method of claim 19, further comprising forming a plurality of driving chips at the periphery area.

21. The method of claim 20, further comprising connecting the driving chips with the circuit film.
